(19) United States
(12) Patent Application Publication
(10) Pub. No.: US 2023/0182072 A1
(43) Pub. Date: Jun. 15, 2023

(54) CARBON FIXATION APPARATUS FOR POWER GENERATION

(71) Applicant: AONBARR INC., Shizuoka (JP)

(72) Inventor: Shigetoshi SAKURAI, Shizuoka (JP)

(21) Appl. No.: 17/925,094

(22) PCT Filed: May 12, 2021
(86) PCT No.: PCT/JP2021/017991

§ 371 Date: Nov. 14, 2022

(30) Foreign Application Priority Data
May 13, 2020 (JP) 2020-084661

(51) Int. Cl. B01D 53/62; B01D 53/81; C01B 32/05

(52) U.S. Cl. CPC B01D 53/62; B01D 53/81; C01B 32/05

(57) ABSTRACT

Disclosed is a carbon fixation apparatus includes a reaction chamber in which a reaction of carbon dioxide with magnesium is caused, a supply device for supplying a pressurized, carbon dioxide-rich introduction gas to the reaction chamber, a second pulse power wave irradiator for irradiating the interior of the reaction chamber with a pulse power wave to produce a streamer discharge, a power generation device for generating power using the energy of gases and supplied from the reaction chamber in response to the reaction, and a vent device for venting a remaining gas from the power generation device.

### TECHNICAL FIELD

The present invention relates to a carbon fixation apparatus for power generation.

### BACKGROUND ART

Conventionally, carbon fixation techniques for the reduction of carbon dioxide generated in association with the combustion of fossil fuels in thermal power generation, gas flaring, and the like are known. According to some of such techniques, carbon dioxide is allowed to react with metal oxides to perform carbon fixation. In addition, there also is a carbon fixation apparatus in which reaction heat generated in association with such a reaction is utilized for power generation, thereby improving the energy efficiency (see, e.g., PTL 1).

PTL 1 describes a carbon fixation apparatus for power generation, including a reaction chamber, a communication path communicating with the upstream side of the reaction chamber, and a power generator capable of generating power in response to the rotation of a steam turbine. An introduction gas containing carbon dioxide generated by the combustion of coal flows into the reaction chamber through the communication path, and, in a state where the gas and calcium oxide are mixed, the temperature inside the reaction chamber is adjusted to 750° C. As a result, carbon dioxide is allowed to react with calcium oxide in the reaction chamber to promote the production of calcium carbonate (carbonation), whereby carbon fixation is performed, while reaction heat generated in association with the reaction is recovered, and the turbine is rotated by steam generated utilizing the recovered heat, whereby power generation by the power generator is enabled.

### CITATION LIST

### Patent Literature

PTL 1: JPH11-192416A (pp. 4 and 5, FIG. 8)

### SUMMARY OF INVENTION

### Technical Problem

However, in a carbon fixation apparatus for power generation like that of PTL 1, because carbon dioxide is allowed to react with calcium oxide so as to perform carbon fixation by carbonation, the temperature inside the reaction chamber has to be maintained at 780° C. or less, and it has thus been difficult to improve the power generation efficiency.

The invention has been accomplished focusing on such problems, and an object thereof is to provide a novel carbon fixation apparatus for power generation, which exhibits high power generation efficiency.

### Solution to Problem

In order to solve the above problems, the carbon fixation apparatus for power generation according to the present invention includes: a reaction chamber in which a reaction of carbon dioxide with magnesium is caused; a supply device configured to supply a pressurized, carbon dioxide-rich introduction gas to the reaction chamber; a second pulse power wave irradiator configured to irradiate interior of the reaction chamber with a pulse power wave to produce a streamer discharge; a power generation device configured to generate power using the energy of a gas supplied from the reaction chamber in response to the reaction; and a vent device configured to vent a remaining gas from the power generation device.

According to the aforesaid feature of the present invention, by irradiating a pressurized, carbon dioxide-rich introduction gas with a pulse power wave to produce a streamer discharge, it was possible to cause a reaction between magnesium and carbon dioxide even when the carbon dioxide-rich gas substantially contained components other than carbon dioxide. As a result, at least magnesium oxide and carbon are produced, whereby carbon fixation is achieved, and, at the same time, this reaction reaches a high temperature of 1,000° C. or more, so the power generation efficiency of the power generation device is high.

It may be preferable that the introduction gas supplied from the supply device to the reaction chamber has a carbon dioxide concentration of 10 to 80 vol %. According to this preferable configuration, the range of heat generated during the reaction reaches about 1,500° C. to 2,000° C. Therefore, there is a wide range of choices for the structure bodies that constitute the reaction chamber and the power generation device, and these structures can be simplified.

It may be preferable that the supply device has a first pulse power wave irradiator configured to irradiate, with a pulse power wave, the introduction gas before being supplied to the reaction chamber. According to this preferable configuration, NOₓ contained in a gas before being supplied to the reaction chamber can be reduced. Therefore, no reaction occurs between NOₓ and magnesium, and the reaction efficiency between magnesium and carbon dioxide can be improved.

It may be preferable that the apparatus further includes a separator disposed downstream of the reaction chamber and configured to separate carbon dioxide and carbon monoxide, and a circulation device configured to supply a gas from which carbon monoxide has been separated by the separator to the supply device. According to this preferable configuration, a gas from which carbon monoxide has been separated is supplied to the supply device and thus can be subjected to carbon fixation again in the reaction chamber. Therefore, the amount of carbon dioxide contained in the remaining gas can be reduced.

### BRIEF DESCRIPTION OF DRAWINGS

FIG. 1 is a schematic diagram showing the carbon fixation apparatus for power generation according to an embodiment of the present invention.

### DESCRIPTION OF EMBODIMENTS

The invention aims at the simultaneous achievement of completely novel carbon fixation and power generation, which has been motivated by the finding that when pulse power wave irradiation is performed in a state where magnesium (Mg) and carbon dioxide (CO₂) are mixed, a direct reaction between Mg and CO₂ can be caused. Further, it has also been found that when a reaction between Mg and CO₂ is caused in a state where the CO₂ concentration is relatively higher than the atmosphere, although CO₂ does not completely react with Mg, and carbon monoxide (CO) is partially produced, the reaction temperature does not reach a super high temperature, such as about 3,000° C. For reference, when the CO₂ concentration is high, for example, 95% or more, CO₂ reacts almost completely with Mg, and magnesium oxide (MgO) and carbon (C) are produced. Although CO is not produced, the temperature reaches about 3,000° C. or more.

Hereinafter, modes for implementing the carbon fixation apparatus for power generation according to the invention will be described based on embodiments.

### Embodiments

A carbon fixation apparatus for power generation 10 of this example is configured such that carbon fixation and power generation are possible using a carbon dioxide-rich introduction gas A1 generated by the combustion of fossil fuels in a combustion furnace 1 of a thermal power plant.

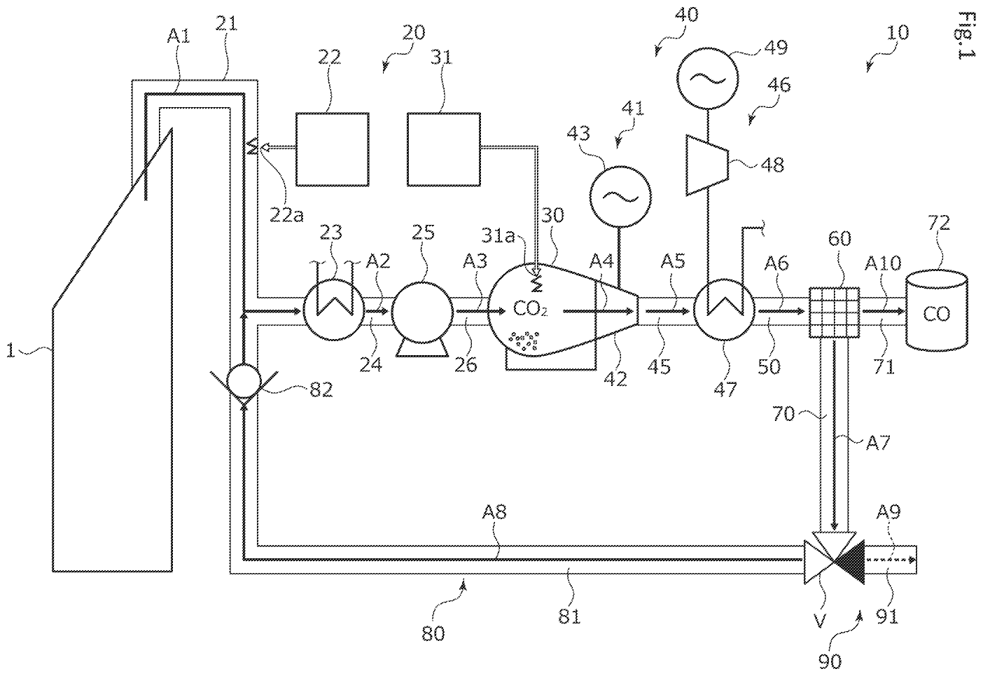

As shown in FIG. 1, the carbon fixation apparatus 10 includes a reaction chamber 30 for causing a reaction of carbon dioxide (CO₂) with magnesium (Mg), a supply device 20 for compressing a CO₂-rich introduction gas A1 and supplying the same to the reaction chamber 30, a second pulse power wave irradiator 31 for irradiating the interior of the reaction chamber 30 with a pulse power wave, a power generation device 40 for generating power using the energy of gases A4 and A5 supplied from the reaction chamber 30, a separator 60 disposed downstream of the power generation device 40 and capable of separating CO₂ and carbon monoxide (CO), a circulation device 80 for supplying a CO₂-containing gas A8 from which CO has been separated by the separator 60 to the supply device 20, and a vent device 90 for venting a remaining gas A9 whose energy has been used by the power generation device 40 to generate power. Incidentally, in the following description, the combustion furnace 1 side of the thermal power plant will be described as the upstream side, while the below-described ninth communication path 91 side of the vent device 90 will be described as the downstream side.

First, the supply device 20 will be described. The supply device 20 is composed mainly of, from the upstream side, a first communication path 21 connected to the downstream side of the combustion furnace 1, a first pulse power wave irradiator 22 for irradiating the interior of the first communication path 21 with a pulse power wave, a cooler 23 disposed downstream of the first communication path 21, a second communication path 24 disposed downstream of the cooler 23, an axial flow compressor 25 connected to the downstream side of the second communication path 24, and a third communication path 26 connected to the downstream side of the compressor 25 and the upstream side of the reaction chamber 30.

The first communication path 21 is connected not only to the combustion furnace 1, but also to the below-described check valve 82 of the circulation device 80, allowing a gas A8 to flow into the first communication path 21 from the check valve 82.

The first pulse power wave irradiator 22 is capable of executing a first pulse streamer discharge from a plug 22a placed in the first communication path 21 and upstream of where the path 21 meets the below-described check valve 82. In this example, the first pulse power wave irradiator 22 can generate a high voltage with a half-value width of 80 ns through repeated operations. With a charge voltage of 20 kV and a discharge current of 170 A, the power source is operated at 5 pps (Pulses Per Second) to perform first pulse power wave irradiation, thereby producing a first pulse streamer discharge. It is important that the operation is short-pulse, high-voltage and low-current, and short-cycle in this manner so as to avoid a glow discharge or an arc discharge.

The reaction chamber 30 is formed to be highly heat resistant and highly pressure resistant, and a Mg powder can be fed from a feed port (not shown). In addition, in the reaction chamber 30, a plug 31a of the second pulse power wave irradiator 31 is placed so that a second pulse streamer discharge can be executed in the reaction chamber 30. In addition, the reaction chamber 30 has placed therein, on the downstream side, a turbine 42 of a gas turbine power generator 41. In this example, the second pulse power wave irradiator 31 can generate a high voltage with a half-value width of 40 ns through repeated operations. With a charge voltage of 100 kV and a discharge current of 170 A, the power source is operated at 10 pps to perform second pulse power wave irradiation, thereby producing a second pulse streamer discharge. It is important that the operation is short-pulse, high-voltage and low-current, and short-cycle in this manner so as to avoid a glow discharge or an arc discharge.

The power generation device 40 has, from the upstream side, a gas turbine power generator 41 capable of generating power using a high-temperature, high-pressure gas A4 generated as a result of the reaction between CO₂ and Mg in the reaction chamber 30, a fourth communication path 45 connected to the downstream side of the turbine 42 (the reaction chamber 30) of the gas turbine power generator 41, and a steam turbine power generator 46 capable of generating power using a high-temperature gas A5.

The gas turbine power generator 41 is composed mainly of the turbine 42 that is rotated by the pressure of the high-temperature, high-pressure gas A4, and a power generator 43 capable of generating power in response to the rotation of the turbine 42. The steam turbine power generator 46 is composed mainly of a cooler 47 for cooling the high-temperature gas A5, a turbine 48 that is rotated by steam generated during the cooling of the gas A5 by the cooler 47, and a power generator 49 capable of generating power in response to the rotation of the turbine 48.

The separator 60 is disposed downstream of a fifth communication path 50 connected to the downstream side of the cooler 47 of the steam turbine power generator 46. In addition, the downstream side of the separator 60 has connected thereto a sixth communication path 70, where a gas A7 obtained by recovering CO from the gas A6 flows in, and an eighth communication path 71, where a gas A10 with an increased CO concentration due to recovered CO flows in. In addition, the downstream side of the eighth communication path 71 has connected thereto a storage tank 72.

The circulation device 80 is composed mainly of the sixth communication path 70, a three-way valve V connected to the downstream side of the sixth communication path 70, a seventh communication path 81 connected to one downstream side of the three-way valve V, and a check valve 82 connected to the downstream side of the seventh communication path 81.

The vent device 90 is composed mainly of the sixth communication path 70, the three-way valve V, and a ninth communication path 91 connected to the other downstream side of the three-way valve V and communicating with the outside of the carbon fixation apparatus 10. Incidentally, in FIG. 1, the valve of the three-way valve V to which the ninth communication path 91 is connected is closed.

Next, the operation will be described. A CO₂-rich introduction gas A1 generated by the combustion of fossil fuels in the combustion furnace 1 flows into the first communication path 21. The introduction gas A1 has a CO₂ concentration of about 55%, and, in addition to CO₂, also contains nitrogen (N₂), hydrogen (H₂), oxygen (O₂), water vapor (H₂O), nitrogen oxides (NOₓ), ammonia (NH₃), and the like. In addition, the temperature of the introduction gas A1 is about 300° C., and the flow rate per unit time is 0.1×10⁻⁴ m³/s.

As indicated by the arrow, in the introduction gas A1 introduced into the first communication path 21, due to the non-thermal equilibrium plasma generated by a first pulse streamer discharge that is generated by continuous irradiation from the plug 22a of the first pulse power wave irradiator 22, the reactions of H₂, O₂, H₂O, NOₓ, NH₃, and the like contained in the introduction gas A1 are promoted to produce N₂, O₂, ammonium nitrate (NH₄NO₃), and the like. That is, the NOₓ concentration of the introduction gas A1 is reduced. Incidentally, the supply device 20 is equipped with a recovery vessel (not shown) for recovering NH₄NO₃.

The introduction gas A1 with a reduced NOₓ concentration is, as indicated by the arrow, led to the cooler 23 and cooled to become a gas A2 of about 30° C. The gas A2 is, as indicated by the arrow, after passing through the second communication path 24, compressed by the compressor 25. Incidentally, water or water vapor flowing through the cooler 23 warmed by the heat of the introduction gas A1 can also be used for power generation by the steam turbine power generator 46.

As indicated by the arrow, a compressed/pressurized gas A3 having a pressure of about 2.0 MPa and a flow rate per unit time of 5.0×10⁻⁵ m³/s passes through the third communication path 26 and flows into the reaction chamber 30 containing a Mg powder. In the reaction chamber 30, a short-time second pulse streamer discharge is carried out from the plug 31a of the second pulse power wave irradiator 31 to generate a non-thermal equilibrium plasma in the reaction chamber 30. It was confirmed that due to this non-thermal equilibrium plasma, CO₂ contained in the gas A3 directly reacted with Mg to produce magnesium oxide (MgO), carbon (C), CO, and the like. That is, carbon fixation of CO₂ was achieved, and the CO₂ concentration of the gas A3 was reduced.

As a result of this reaction, reaction heat was generated, and the temperature inside the reaction chamber 30 reached about 1,500° C. to about 2,000° C. It was observed that even after the second pulse power wave irradiation was stopped, as the gas A3 flowed into the reaction chamber 30, CO₂ and Mg continuously reacted with each other.

In this manner, in a state where Mg and CO₂ have not yet reacted, the second pulse streamer discharge can be used as a trigger to cause a reaction between Mg and CO₂, and, after the reaction between Mg and CO₂ has started, the reaction can be continuously continued by the generated high-temperature reaction heat.

In addition, due to the reaction between CO₂ and Mg, the temperature of the gas A3 rises rapidly. In association with such a rise, the gas A3 expands rapidly to become a high-temperature, high-pressure gas A4 and is emitted to the downstream side.

As indicated by the arrow, the gas A4 attempts to flow from the downstream side of the reaction chamber 30 into the fourth communication path 45. At this time, the gas A4 rotates the turbine 42 of the gas turbine power generator 41 disposed between the reaction chamber 30 and the fourth communication path 45. In association with the passage of the gas A4, the turbine 42 is rotated, whereby the power generator 43 of the gas turbine power generator 41 generates power.

The high-temperature gas A5 that has flowed into the fourth communication path 45 flows into the cooler 47 of the steam turbine power generator 46 and is cooled to become a gas A6 of about 100° C. to 150° C. Water vapor generated in association with this cooling rotates the turbine 48 of the steam turbine power generator 46, whereby the generator 49 of the steam turbine power generator 46 generates power.

The gas A6 cooled by the cooler 47 is, as indicated by the arrow, led to the separator 60 through the fifth communication path 50. In the separator 60, CO contained in the gas A6 is separated. Thus, the gas A6 is separated into a gas A10, which contains a high concentration of CO, and a gas A7, which is the remaining gas from which CO has been separated. The gas A10 containing a high concentration of CO is, as indicated by the arrow, sealed in a storage tank 72 through the eighth communication path 71.

Meanwhile, the gas A7, which is the remaining gas from which CO has been separated, is, as indicated by the arrow, led to the sixth communication path 70. The sixth communication path 70 is equipped with a concentration sensor (not shown) capable of measuring the concentration of CO₂ contained in the gas A7. In the case of the gas A8 whose CO₂ concentration is higher than a certain level (in this example, 10 vol %), the ninth communication path 91 side of the three-way valve V is closed, while the sixth communication path 70 side and the seventh sixth communication path 81 side are opened. As a result, the gas A8 is, as indicated by the arrow, led to the first communication path 21 through the three-way valve V, the seventh communication path 81, and the check valve 82, and, together with the introduction gas A1, repeatedly goes through the above cycle.

In addition, in the case of the remaining gas A9 whose CO₂ concentration is lower than a certain level (in this example, 10 vol %), the seventh communication path 81 side of the three-way valve V is closed, while the sixth communication path 70 side and the ninth communication path 91 side are opened. As a result, the remaining gas A9 is, as indicated by the dotted arrow, vented to the outside through the three-way valve V and the ninth communication path 91.

As described above, in the carbon fixation apparatus 10 of this example, the pressurized, carbon dioxide-rich introduction gas A3 is irradiated with a pulse power wave from the second pulse power wave irradiator 31 to produce a second pulse streamer discharge. Accordingly, even though the carbon dioxide-rich gas A3 substantially contained components other than carbon dioxide, it was possible to cause a reaction between magnesium and carbon dioxide. As a result, at least magnesium oxide and carbon are produced, whereby carbon fixation is achieved, and, at the same time, because this reaction reaches a high temperature of 1,000° C. or more, a high-temperature, high-pressure gas A4 is produced, and thus the power generation efficiency of the power generation device 40 is high.

In addition, the introduction gas A1, which is to be introduced into the reaction chamber 30, has a carbon dioxide concentration of about 55%, and the range of heat generated during the reaction between carbon dioxide and magnesium is about 1,500° C. to 2,000° C. Meanwhile, in the case where the introduction gas has a carbon dioxide concentration of 90% or more, the range of heat generated during the reaction between carbon dioxide and magnesium is about 2,500° C. to about 3,000° C. or more. Therefore, the carbon fixation apparatus 10 of this example, in which the range of heat generated during the reaction is relatively low-temperature, has a wider range of choices for the structure bodies that constitute the reaction chamber 30 and the power generation device 40, and these structures can be simplified.

In addition, because NOₓ contained in the introduction gas A1 before being supplied to the reaction chamber 30 can be reduced by a pulse streamer discharge generated by the first pulse power wave irradiator 22, no reaction occurs between NOₓ and magnesium, and the reaction efficiency between magnesium and carbon dioxide can be improved.

In addition, when a comparison is made between a case where the range of heat generated during the reaction in the reaction chamber is about 1,500° C. to about 2,000° C. as in the carbon fixation apparatus 10 of this example and a case where the range of heat generated during the reaction in the reaction chamber is about 2,500° C. to about 3,000° C. or more unlike this example, the amount of carbon dioxide that undergoes carbon fixation in a single reaction between carbon dioxide and magnesium is smaller in the carbon fixation apparatus 10 of this example. Meanwhile, the carbon fixation apparatus 10 of this example has the separator 60, which is disposed downstream of the reaction chamber 30, and the circulation device 80, which supplies a gas A8 containing carbon dioxide from which carbon monoxide has been separated by the separator 60 to the first communication path 21. Thus, by supplying the carbon dioxide-containing gas A8 again to the first communication path 21, carbon fixation can be performed again in the reaction chamber 30, making it possible to reduce carbon dioxide contained in the remaining gas A9.

In addition, thermal power plants, to which the carbon fixation apparatus 10 of this example is applied, are often built along the ocean because a cooling step using cooling water is indispensable in thermal power generation, and it is necessary to secure a water source. In such an ocean-side facility, seawater can be easily supplied, and thus seawater can be used as the magnesium supply source. That is, because magnesium can be easily supplied, the cost of carbon fixation can be reduced.

An example of the invention has been described above with reference to the drawing. However, specific configurations are not limited thereto, and any changes or additions without departing from the scope of the invention are encompassed by the invention.

For example, although a configuration applied to a thermal power plant has been described in the above example, there is no limitation thereto. It can be applied to any facility where a gas having a carbon dioxide concentration of 10 to 80 vol % is generated.

In addition, although a pulse streamer discharge by the first pulse power wave irradiator 22 is carried out in the first communication path 21 in the above-described configuration, there is no limitation thereto. The discharge is not limited as long as it is carried out within a range before the introduction into the reaction chamber 30, and may be carried out in the second communication path 24 after cooling by the cooler 23, or in the third communication path 26 after compression by the compressor 25.

In addition, although the compressor 25 is separated from the gas turbine power generator 41 in the above-described configuration, there is no limitation thereto. The configuration may also be such that the gas is compressed using the rotational force of the turbine 42 of the gas turbine power generator 41 rotated by the gas A4.

In addition, although a short-time second pulse streamer discharge is applied as a trigger for causing a reaction between Mg and CO₂ in the above-described configuration, there is no limitation thereto. The configuration may also be such that a temperature sensor is placed in the reaction chamber 30, and a second pulse streamer discharge is applied each time the temperature measured by the temperature sensor reaches 1,500° C. or less. Further, the configuration may also be such that a second pulse streamer discharge is continuously applied over the duration of the continuous reaction between Mg and CO₂.

### REFERENCE SIGNS LIST

10: Carbon fixation apparatus

20: Supply device

22: First pulse power wave irradiator

30: Reaction chamber

31: Second pulse power wave irradiator

40: Power generation device

60: Separator

80: Circulation device

90: Vent device

A1: Introduction gas

A3: Pressurized, carbon dioxide-rich introduction gas

A9: Remaining gas

1. A carbon fixation apparatus for power generation, comprising:
a reaction chamber in which a reaction of carbon dioxide with magnesium is caused;
a supply device configured to supply a pressurized, carbon dioxide-rich introduction gas to the reaction chamber;
a second pulse power wave irradiator configured to irradiate interior of the reaction chamber with a pulse power wave to produce a streamer discharge;
a power generation device configured to generate power using the energy of a gas supplied from the reaction chamber in response to the reaction; and
a vent device configured to vent a remaining gas from the power generation device.

2. The carbon fixation apparatus for power generation according to claim 1, wherein the introduction gas supplied from the supply device to the reaction chamber has a carbon dioxide concentration of 10 to 80 vol %.

3. The carbon fixation apparatus for power generation according to claim 1, wherein the supply device has a first pulse power wave irradiator configured to irradiate, with a pulse power wave, the introduction gas before being supplied to the reaction chamber with a pulse power wave.

4. The carbon fixation apparatus for power generation according to claim 1, further comprising:
a separator disposed downstream of the reaction chamber and configured to separate carbon dioxide and carbon monoxide; and
a circulation device configured to supply a gas from which carbon monoxide has been separated by the separator to the supply device.

5. The carbon fixation apparatus for power generation according to claim 2, wherein the supply device has a first pulse power wave irradiator configured to irradiate, with a pulse power wave, the introduction gas before being supplied to the reaction chamber with a pulse power wave.

6. The carbon fixation apparatus for power generation according to claim 2, further comprising:
a separator disposed downstream of the reaction chamber and configured to separate carbon dioxide and carbon monoxide; and
a circulation device configured to supply a gas from which carbon monoxide has been separated by the separator to the supply device.

7. The carbon fixation apparatus for power generation according to claim 3, further comprising:
a separator disposed downstream of the reaction chamber and configured to separate carbon dioxide and carbon monoxide; and
a circulation device configured to supply a gas from which carbon monoxide has been separated by the separator to the supply device.
